(19) United States
(12) Patent Application Publication
(10) Pub. No.: US 2018/0167550 A1
(43) Pub. Date: Jun. 14, 2018

(54) CAMERA SYSTEM AND OPERATING METHODS THEREFOR

(71) Applicant: Matrix Vision GmbH Bildverarbeitung, Oppenweiler (DE)

(72) Inventor: Uwe Hagmaier, Oppenweiler (DE)

(73) Assignee: Matrix Vision GmbH Bildverarbeitung, Oppenweiler (DE)

(21) Appl. No.: 15/799,372

(22) Filed: Oct. 31, 2017

(30) Foreign Application Priority Data
Nov. 2, 2016 (DE) 102016120845.0

(51) Int. Cl. H04N 5/232

(52) U.S. Cl. CPC H04N 5/23216; H04N 5/23229

(57) ABSTRACT

The invention relates to a camera system with an image sensor for generating primary image data and at least one interface unit for the data exchange with an external unit, wherein the camera system is designed to store at least a portion of the primary image data generated by the image sensor at least temporarily in a storage unit associated with the camera system.

### CROSS-REFERENCE TO RELATED APPLICATIONS

This application claims priority to German Application Serial Number 102016120845.0, filed Nov. 2, 2016, the entire disclosure of which is incorporated herein by reference.

### BACKGROUND OF THE INVENTION

The invention relates to a camera system with an image sensor for generating primary image data and with at least one interface unit for the data exchange with an external unit.

The invention further relates to an operating method for such a camera system.

Moreover, the invention relates to an image processing system with at least one camera system and to an operating method for such an image processing system.

Camera systems of the type mentioned at the start are known and have the disadvantage that, in particular in the case of relatively high optical resolutions of the image sensor, the quantity of primary image data generated per time unit can under some circumstances no longer be transmitted via the interface element.

Accordingly, the aim of the present invention is to further develop a camera system and an operating method of the type mentioned at the start, in that the above-mentioned disadvantages of the prior art are avoided and a more flexible use is enabled.

This aim is achieved in the camera system of the type mentioned at the start according to the invention in that the camera system is designed to store a portion of the primary image data generated by the image sensor at least temporarily in a storage unit associated with the camera system, in order to obtain stored primary image data, to subject at least a portion of the primary image data generated by the image sensor and/or of the stored primary image data to a data reduction by means of a data reduction unit, in order to obtain secondary image data, and to output at least a portion of the secondary image data to the external unit via the at least one interface unit.

Thereby it is advantageously ensured that the external unit can be supplied, for example, continuously, with the secondary image data, without thereby overloading the interface unit or a data interface between the camera system and the external unit. At the same time, it is advantageously ensured according to the invention that the stored primary image data, which is preferably not subjected to any data reduction, can be kept available at least temporarily for any required analysis.

For example, a computer system of an image processing system can continuously obtain secondary image data from the camera system according to the invention and analyze it according to a presettable image processing task for the image processing system. To the extent that an image quality or the information content of the secondary image data is temporarily insufficient, it is possible, due to the at least temporary storage according to the invention of the primary image data in the storage unit of the camera system, to use this primary image data. Thereby, it is advantageously ensured that, at least for a certain time period during which the stored primary image data is kept (for example, depending on the storage capacity of the storage system), the primary image data generated by the image sensor is available at the maximum possible quality and can be retrieved, for example, by the external unit.

In some embodiments it is possible to provide that the camera system is designed to at least temporarily store or buffer the secondary image data obtained by means of the data reduction unit. For this purpose, in an embodiment, a separate storage unit can be provided. In other embodiments, it is also conceivable to (also) use a certain storage area of the storage unit provided for storing the primary image data for the at least temporary storage of the secondary image data.

In a preferred embodiment, it is provided that the camera system is designed to receive at least one control command containing control information from an external unit, wherein, in particular, the camera system is designed to influence an operation of the camera system depending on the control information. As a result, a particularly flexible operation of the camera system is ensured, and the possibility exists, for example, that computer systems of image processing systems according to the invention can influence the operating behavior of the camera system.

In a particularly preferable embodiment, the camera system is designed to output, depending on the control information, at least a portion of the stored primary image data to the external unit. This is advantageous, for example, if the external unit, for example, a computer unit of an image processing system, during the analysis of the secondary image data ordinarily transmitted by the camera system to the external unit, has determined that thereby corresponding image data of higher quality or with higher information content should be retrieved from the camera system. In this case, the external unit can transmit, for example, a control command to the camera system, which contains control information which, according to the invention, causes the camera system to transmit primary image data at least temporarily stored in the storage unit thereof to the external unit, in accordance with the control command received.

For example, in an embodiment, the camera system, depending on the control information, can output the primary image data present at maximum quality to the external unit.

In another embodiment, it is possible to provide that the camera system outputs image data at a lower quality than maximum quality to the external unit, wherein the quality of the image data output to the external unit is specified, for example, by the control information.

In another advantageous embodiment, it is provided that the control information defines an area, for example, a two-dimensional area, which characterizes a portion of at least one image of the primary image data (so-called area of interest, AOI). In this embodiment, after receiving the corresponding control information, the camera system can thus output only the portion of the image data defined by the control information to the external unit.

In another advantageous embodiment, it is provided that the camera system marks the image data to be output to the external unit. For example, the image data to be output can be provided with an identification feature indicating that the image data to be output was requested subsequently by means of the control information and then output by the camera system to the external unit. As a result, in the area of the external unit, advantageously a distinction can be made between originally obtained secondary image data and, for example, stored primary image data requested, for example, by means of the above-mentioned control information.

In another advantageous embodiment, it is possible to provide that, depending on control information received by means of a control command, the camera system controls an operation of the data reduction unit, which has an effect on a possible reduction of the data quantity in the transformation of the primary image data into the secondary image data. In this manner, for example, a degree of data reduction can be changed dynamically, that is to say during the operating time of the camera system, for example, in order to take into consideration different operating states of a computer system executing image processing tasks.

In another advantageous embodiment, it is provided that the data reduction unit is designed to carry out one or more of the following procedures, wherein these procedures or this procedure is/are carried out in particular with regard to the generated primary image data and/or the stored primary image data:

reducing a local resolution of the image data

reducing a spectral resolution of the image data

reducing an amplitude resolution of the image data

reducing an image rate

providing the image data with an identification feature.

In a preferred embodiment, the reduction of the local resolution of the image data can occur in one dimension, for example, in a width dimension or in a height dimension.

In another preferred embodiment, the reduction of the local resolution of the image data can occur in at least two dimensions, for example, in width and height dimensions.

In the case of image data with more than two dimensions, for example, image data which additionally has a depth dimension or another dimension, the reduction of the local resolution of the image data can advantageously also be applied to more than two dimensions or also to only a depth dimension and the like.

For example, the reduction of the local resolution can be carried out uniformly on image data or the individual images characterizing the image data, for example, by means of undersampling along the corresponding dimension. In a particularly simple embodiment, for example, from a two-dimensional image, every other pixel can be selected along a width dimension, and every other pixel can be selected along a height dimension, whereby a significant data reduction is already achieved.

In another advantageous embodiment, the reduction of a spectral resolution of the image data can comprise, for example, the omission of one or more color channels. For example, in the case of image data in which each pixel comprises three color channels, for example, red, green, blue, at least one of the color channels can be omitted.

In another advantageous embodiment, the reduction of an amplitude resolution of the image data can comprise, for example, the reduction of a number of quantization steps which are used for representing the amplitude values concerned in the digital domain.

In other embodiments, alternatively or additionally to the above-mentioned reduction steps, at least one image compression procedure known per se, such as, for example, in accordance with the JPEG standard or the JPEG2000 standard or the like, can be used, wherein in some embodiments a lossy compression is considered, and wherein, in other embodiments, a lossless compression is preferably used.

In yet another advantageous embodiment, the image data or parts thereof or individual images can be provided with an identification feature such as, for example, an image number and/or a time stamp or the like. According to other embodiments, it is possible to apply these features to the primary image data and/or the stored primary image data and/or the secondary image data.

In another advantageous embodiment of the camera system according to the invention, it is provided that the storage unit comprises at least one circular buffer whose storage area is cyclically overwritten with newly generated primary image data of the image sensor. In other words, at least one area of the storage unit is organized as a circular buffer. By establishing the size of the circular buffer, a maximum storage duration can be established in a manner known per se for a certain datum or certain image data, before this data is overwritten anew by new primary image generated later.

In another advantageous embodiment, it is possible to provide that the storage unit is organized in such a manner that it has several circular buffers, of which at least one first circular buffer is usable for an at least temporary storage of primary image data, and of which at least one second circular buffer is usable for an at least temporary storage of secondary image data.

The aim of the present invention is furthermore achieved by an image processing system with at least one camera system according to the invention and with at least one computer system, wherein the computer system is designed to receive the secondary image data output by the camera system via the at least one interface unit, to analyze at least a portion of the received secondary image data, and, depending on a result of the analysis, to output at least one control command containing control information to the camera system. As already described above in reference to the camera system, the control command can be used to influence a mode of operation of the camera system, in particular to request at least a portion of stored primary image data and/or to control an operation of the data reduction unit.

In a particularly preferable embodiment, it is therefore provided that the computer system is designed to cause the camera system, by means of a control command, to output at least a portion of the stored primary image data as requested image data to the computer system, and to receive the requested image data from the camera system, wherein, in particular, the computer system analyzes the received requested image data.

The aim of the present invention is further achieved by proposing a method for operating a camera system with an image sensor for generating primary image data and with an interface unit for the data exchange with an external unit.

In a preferred embodiment, the camera system receives at least one control command containing control information from an external unit, wherein the camera system, depending on the control information, outputs at least a portion of the stored primary image data to the external unit and/or, depending on the control information, controls an operation of the data reduction unit.

The aim of the present invention is achieved in yet another manner by means of a method for operating an image processing system.

Additional advantageous designs will in part appear hereinafter.

Below, exemplary embodiments of the invention are explained in reference to the drawing.

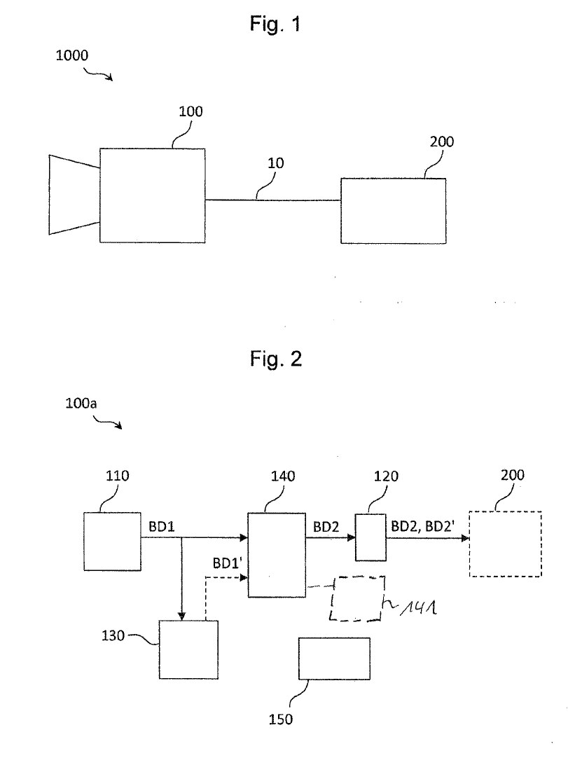

FIG. 1 diagrammatically shows an image processing system according to an embodiment of the invention,

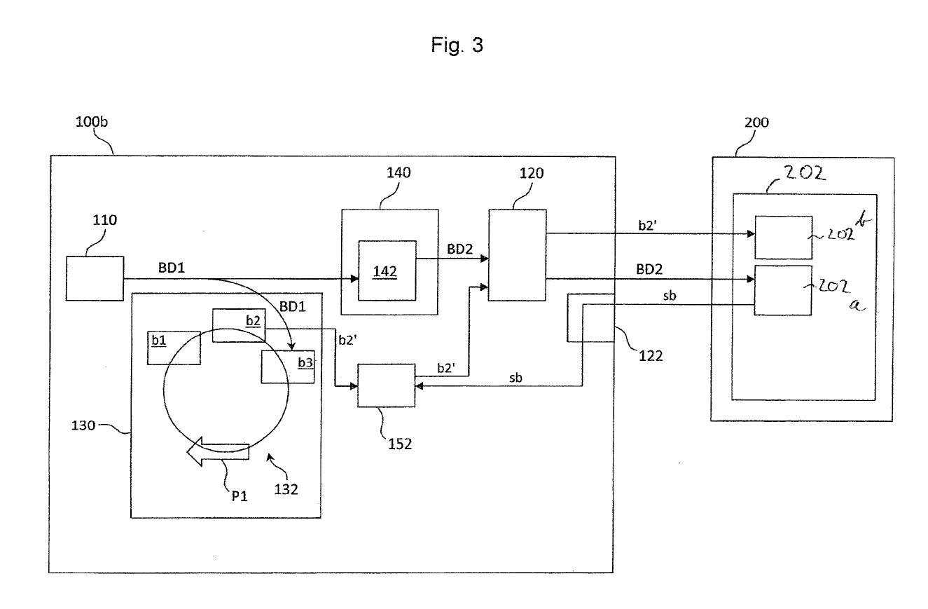

FIG. 2 diagrammatically shows a camera system according to the invention according to an embodiment,

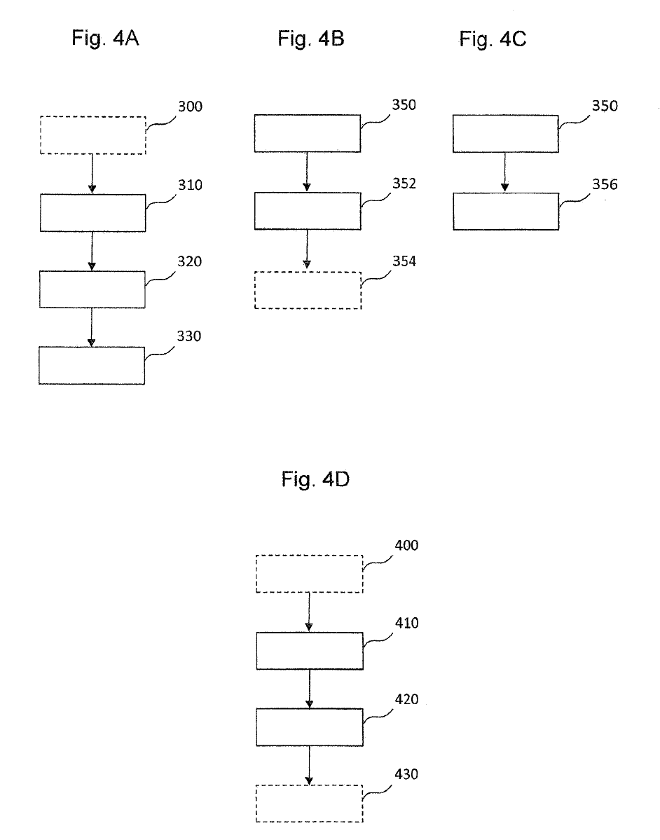

FIG. 3 diagrammatically shows a camera system according to another embodiment,

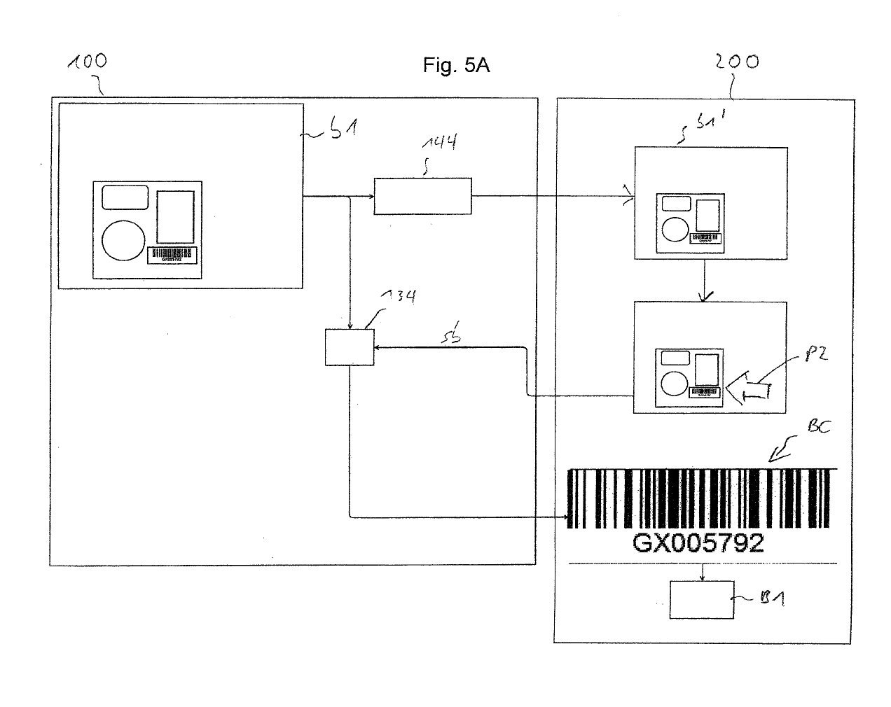

FIG. 4A, 4B, 4C show in each case a simplified flow chart of an embodiment of the operating method according to the invention for a camera system,

FIG. 4D shows a simplified flow chart of an embodiment of the operating method according to the invention for an image processing system,

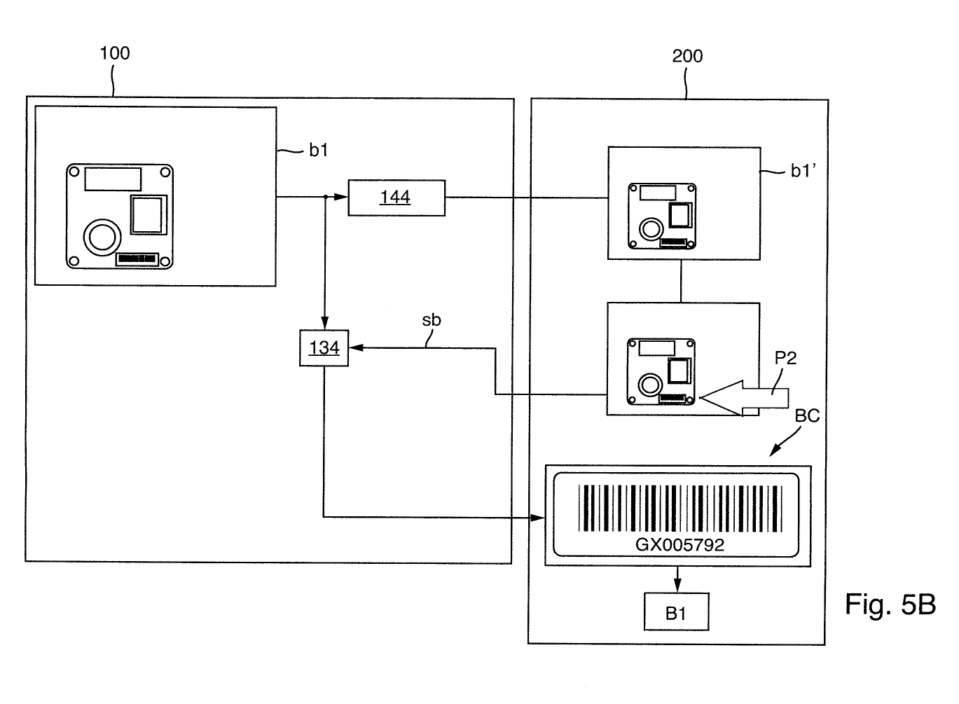

FIG. 5A diagrammatically shows an image processing system according to another embodiment,

FIG. 5B diagrammatically shows a representation similar to FIG. 5A with actual camera images for further illustration, and

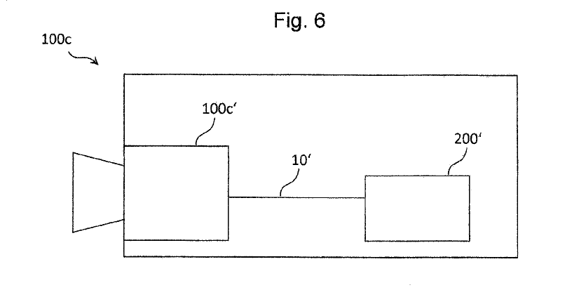

FIG. 6 diagrammatically shows a program of another embodiment.

FIG. 1 diagrammatically shows an image processing system 1000 according to an embodiment of the present invention. The image processing system 1000 comprises a camera system 100 for obtaining image data and a computer or a computer system 200 which is connected in a known manner via a data connection 10 to the camera system 100.

The camera system 100 comprises an image sensor, not shown in FIG. 1, which can generate primary image data. For example, the image sensor can be an image sensor of the CCD (charge coupled device) type, or it can be a sensor of the CMOS (complementary metal oxide semiconductor) type. Other sensor types can also be used for the camera system 100 according to the invention.

While the camera 100 generates primary image data with the image sensor thereof, for example, in the context of industrial image processing, process automation or the like, the computer system 200 performs tasks that are known per se such as, for example, image analysis or image processing. The type and extent of the image analysis and/or image processing can vary considerably depending on the field of application. Via the data connection 10, the computer system 200 is supplied with image data, which the camera system 100 detects by means of the image sensor thereof.

FIG. 2 diagrammatically shows an embodiment 100a of the camera system according to the invention. The camera system 100 according to FIG. 1 can have, for example, the design reproduced in FIG. 2 and explained in greater detail below.

The camera system 100a according to FIG. 2 comprises an image sensor 110, in particular an optical image sensor such as, for example, a CCD sensor or a CMOS sensor. The image sensor 110 generates primary image data BD1 in a manner known per se. The primary image data BD1 generated by the image sensor 110 is characterized inter alia by, for example, a local resolution, in particular a maximum (optical) resolution of the image sensor 110 which is indicated, for example, by the number of pixels that can be provided, for example, in a two-dimensional matrix-like arrangement.

In particular, primary image data BD1 generated by the image sensor 110 can be represented, for example, by a series of digital images. These digital images have, for example, a width which corresponds to a number of pixels or sensor elements of the image sensor 110 along a width coordinate, at a height which corresponds to the number of pixels or sensor elements of the image sensor 110 along a height coordinate orthogonal to the width coordinate.

Moreover, the primary image data BD1 generated by the image sensor 110 can be characterized by a spectral resolution, that is to say, for example, by the presence of one or more color channels, for example, RGB channels or other color channels. It is also conceivable that, in other embodiments, the image sensor 110 is designed as a black-and-white image sensor or works as a gray scale sensor.

Another characteristic of the image sensor 110 is an amplitude resolution which defines how many different brightness values are available for a digital representation of the individual pixels of the primary image data BD1 obtained by the image sensor 110. For example, in an 8-bit amplitude resolution, 2̂8=256 different brightness values or intensity values can be represented; accordingly, in the case of a 16-bit resolution, 2̂16=65536 different brightness or intensity values can be represented, and the like.

Another characteristic of the image sensor 110 is an image rate which, for example, can be indicated in images that can be delivered by the image sensor 110 per second.

In a manner known per se, the above-mentioned criteria or characteristics have an effect on a data quantity which is needed in order to represent the primary image data BD1 generated by the image sensor 110. For many applications, it can be undesirable if the image data BD1, that is to say the image data which represents the best image quality or the highest possible information content of the information delivered by the image sensor 110, is transmitted at the maximum possible image rate to the computer system 200 (FIG. 1), because, on the one hand, possibly, the band width of the data connection 10 is not sufficient for that purpose, and, on the other hand, the computer system 200 receiving the primary image data BD1 has to apply a relatively high computational power in order to process all the image data BD1 or even has to reject a portion of the primary image data BD1.

Therefore, it is proposed according to the invention that the camera system 100a is designed to store at least a portion of the primary image data BD1 generated by the image sensor 100 at least temporarily in a storage unit 130 associated with the camera system 100a. This is indicated in FIG. 2 by the arrow marked with reference numeral BD1, directed toward the storage unit 130. Thereby, stored primary image data BD1′ is obtained, which, as indicated in FIG. 2 by the broken line arrow BD1′, can optionally be retrieved again later from the storage unit 130.

In addition, the camera system 100a is designed according to the invention to subject at least a portion of the primary image data BD1 generated by the image sensor 110 to a data reduction, which is carried out by the data reduction unit indicated in FIG. 2 with reference numeral 140. The purpose of the data reduction is a reduction of the data quantity of the image data or, expressed precisely, of the primary image data BD1 which is supplied to the data reduction unit 140.

By the data reduction, the data reduction unit 140 generates secondary image data BD2 which corresponds to a lower data quantity or requires a smaller data volume for the representation thereof.

In another embodiment, it is also possible to provide that the data reduction unit 140 uses stored primary image data BD1 as input data for the data reduction.

According to the invention, the secondary image data BD2 obtained at the output of the data reduction unit 140 or at least a portion of the secondary image data BD2 is output via an interface unit 120 to an external unit 200, for example, to the computer system 200 of the image processing system 1000 (FIG. 1). Thereby, it is ensured that the computer system 200 is always supplied with current image data delivered by the image sensor 100, and, in particular, with the data-reduced variant in the form of the secondary image data BD2, as a result of which advantageously lower band width requirements are imposed on the data connection 10 (FIG. 1) than if the primary image data BD1 not already been subjected to a data reduction would have to be transmitted directly to the external unit 200.

For the case in which the computer system 200 requires, instead of or in addition to the data-reduced secondary image data BD2, the primary image BD1 generated originally by the image sensor 110, which as a rule has a greater information content than the data-reduced secondary image data BD2, said primary image data can be advantageously used, since, however, the primary image data BD1 in the form of the stored primary image data BD1′ is kept available in the storage unit 130 at least temporarily, for example, for a certain calculated time period for the generation by the image sensor 110. For example, in such cases, the computer system 200 can request from the camera system 100a the transmission of certain stored primary image data BD1′. Such a transmission can occur, for example, directly from the storage unit 130 via the data interface 120 and then the data connection 10 (FIG. 1) to the external unit 200 or the computer system 200.

Alternatively, as indicated in FIG. 2 by the broken-line arrow BD1′, upon such a request of the computer system 200, a certain quantity of stored primary image data BD1′ of interest can be retrieved from the storage unit 130, and this stored primary image data BD1′ of interest can be subjected to a data reduction by the data reduction unit 140, in accordance with the request of the computer system 200, before the transmission to the computer system 200. In the process, for example, a lesser data reduction of a different type can occur, so that, in response to the request of the computer system 200, for example, less data-reduced image data than the previous data-reduced secondary image data BD2 can be transmitted to the computer system 200.

However, in general, the best possible available quality of the primary image data BD1 available from the storage unit 130 is preferably requested by the computer system 200. In this case, such a quantity of primary image data or stored primary image data can be removed from the storage unit 130 and transmitted, for example, via the data interface 120 and the computer system 200 directly, that is to say without any possible data reduction.

The data transmitted “belatedly” upon request of the computer system 200 to the computer system 200, that is to say, for example, the requested portions of the primary stored image data BD1′, is marked in Figure two by the reference numeral BD2′.

In a preferred embodiment, it is possible to provide that, at least temporarily, but also possibly continuously, the secondary image data BD2 formed by the data reduction unit 140 is buffered, in particular for a presettable buffer time. For this purpose, a buffer 141 associated with the data reduction unit 140 can be provided, which, in a preferred embodiment, can be designed similarly to the storage unit 130. Alternatively or additionally, it is possible to provide that the secondary image data BD2 to be buffered is buffered in temporary storage in a storage area of the storage unit 130 provided for this purpose. By means of the above-described optional buffering of the secondary image data BD2, it is ensured that said secondary image data can also be transmitted with temporally offset to the computer system 200 for the generation thereof by the data reduction unit 140, which is advantageous, for example, if the data connection 10 (FIG. 1) to the computer system 200 is momentarily overloaded (for example, by the transmission of subsequently requested primary image data), so that a data rate required for the transmission of the secondary image data BD2 through the data connection 10 is not ensured. As soon as the data rate required for the transmission of the secondary image data BD2 can be made available again through the data connection 10, the buffered secondary image data can be transmitted to the computer system 200.

In addition to the components already described above, FIG. 2 also shows a control unit 150 which can comprise, for example, a central processing unit such as a microcontroller, a digital signal processor (DSP), a programmable logic component, for example, FPGA (Field Programmable Gate Array) or the like or a combination thereof. In a particularly preferable embodiment, the control unit 150 can be provided for the control of the operation of the camera system 100a or of the components thereof. In particular, the control unit 150 can control, for example, the operation of the image sensor 110 and/or of the data reduction unit 140 and/or of the storage unit 130 and/or of the data interface 120.

FIG. 3 diagrammatically shows a block diagram of another embodiment 100b of the camera system according to the invention. As already described above in reference to the embodiment example according to FIG. 2, an image sensor 110 is present, which generates or provides the primary image data BD1. In the present case, the storage unit 130 comprises a circular buffer 132, in which the primary image data BD1 of the image sensor 110 is stored, for example, in the form of digital images, cyclically and in a manner known per se, compare also the block arrow P1. As an example, in FIG. 3, three images b1, b2, b3 are shown. To the extent that a storage area of the storage unit 130, which is available for the circular buffer 132, is completely described by digital images, the oldest stored digital image still present in the circular buffer 132 is then overwritten by a current image newly delivered by the image sensor 110 and so forth. It can be seen that the design of the size of the circular buffer 132 with respect to the data rate or the data quantity of the primary image data BD1 as delivered by the image sensor 110 determines the time for which a certain digital image b1 remains in the circular buffer 132 before it is overwritten by a current subsequent image.

In the embodiment 100b shown in FIG. 3, the data reduction unit 140 comprises, for example, a scaling unit 142 which is designed in order to reduce a local resolution of the digital images delivered by the image sensor 110 in the form of the primary image data BD1, wherein, in the present case, for example, a reduction factor 4 is assumed both in a horizontal dimension (image width) and also in a vertical dimension (image height). As a result, the resolution of the primary image data BD1 is thus reduced by a factor of 4 in each dimension, leading to the secondary image data BD2 obtained by the data reduction unit 140 having a data rate or data quantity which is smaller in comparison to the data rate or data quantity of the primary image data BD1, for example, by the factor of 16. As a result, the burden on the data interface 120 is advantageously lightened. This means that a data band width reduced approximately by the factor of 16 is required for the data connection (FIG. 1) to the computer system 200, in order to transmit the secondary image data BD2 to the computer system 200 at the rate at which the primary image data BD1 is also generated.

The burden on the computer system 200 receiving the secondary image data BD2 is also considerably lightened, since a smaller data quantity per time unit has to be processed. Thus, the computer system 200 can analyze, for example, a scene represented by the secondary image data BD2, which the camera system 100b has recorded, and, for example, determine the position of an object to be examined in further detail or of a code, for example, of a one- or two-dimensional barcode.

To the extent that no object of interest is found by the computer system 200 in a certain digital image of the secondary image data BD2, the computer system 200 waits, for example, for the next digital image of the secondary image data BD2 received thereby and performs a new evaluation in this regard.

To the extent that the computer system 200 finds an image area of interest for the present image processing task in a digital image of the secondary image data BD2, the computer system 200 can send a control command sb to the camera system 100b in order to cause the camera system 100b to output at least a portion of the stored primary image data BD1′ (FIG. 2) as requested image data b2′ (FIG. 3) to the computer system 200.

As can be seen in FIG. 3, the control command sb is transmitted by the computer system 200 via a control interface 122 of the camera system 100b to the camera system 100b, in particular to a functional unit 152 there, which also can be integrated in the control unit 150 described above in reference to FIG. 2. The functional unit 152 evaluates the control command sb and, from the circular buffer 132, it reads out the image requested by the computer system 200 or the requested image data b2′ and transmits it to the computer system 200 using the interface unit 120. The computer system 200 receives the corresponding required image data b2′ and can supply it to further image processing.

By means of the above-described sequence according to a preferred embodiment of the present invention it is advantageously ensured that, if needed, particularly if areas of interest that need to be analyzed in further detail are identified in the secondary image data BD2, the computer system 200 can request, from the camera system 100b, usually high-resolution primary image data BD1 comprising a maximum information content or stored images b2′ which can then be transmitted to the computer system 200.

In another preferred embodiment, a control command sb can contain, for example, control information which denotes a certain digital image b 1 of the primary image data BD1′ stored in the storage unit 130, so that it can be read out in a targeted manner from the circular buffer 132 or the storage unit 130 and transmitted to the computer system 200.

Furthermore, according to other embodiments, such a control command can contain additional control information which characterizes, for example, an image area of interest (AOI, area of interest), typically a rectangular image area, of a digital image. In this case, it is then not necessary, for example, to transmit the complete stored digital image b2′, instead it is sufficient if the section of interest of the stored digital image b2 is transmitted to the computer system 200, whereby the band width requirements imposed on the data connection 10 (FIG. 1) are further reduced.

Particularly advantageously, in an embodiment, using an image number and optionally using coordinate values which characterize at least one image area, the camera system 100b can localize the stored primary image data of interest to the computer system 200 in the storage unit 130 or in the circular buffer 132 thereof and then transmit it to the computer system 200.

In another advantageous embodiment, it is provided that a special identification can be associated with the image data, for example, integrated in the image data and/or integrated in associated metadata, wherein this special identification enables the receiving computer system 200, for example, to recognize that a subsequently requested image or subsequently requested stored primary image data BD1′ is involved.

Furthermore, such a special identification can be designed so that it thus enables an association showing to which digital image or to which portion of the previously received secondary image data BD2 the special identification or the image identified thereby belongs. For example, in other embodiments, at least one time stamp can be used as identification in the above-mentioned sense, in order to enable a subsequent targeted requesting of stored primary image data of interest to the computer system 200. For example, it is conceivable that the secondary image data BD2, for example, individual images thereof, particularly preferably all the images thereof, is provided in each case with a time stamp formed, for example, by the camera system 100. After the reception of the corresponding secondary image data, based on a time stamp in an image of the received secondary image data BD2, the computer system 200 can thereby request in a targeted manner corresponding primary image data from the camera system 100, for example, by transmission of a value characterizing the time stamp.

In other embodiments, it is possible that the secondary image data is not provided directly with the time stamp as described above (for example, as associated data value or integrated in associated metadata of corresponding images). Instead, the time stamp can also be transmitted through a separate communication channel from the camera system 100 to the computer system 200. The separate communication channel can be implemented, for example, using a virtual connection via the interfaces 10, 120 already described above, or also by a separate physical data connection (wired or wireless, not shown) between the systems 100, 200.

In another embodiment, it is also conceivable that the time stamps are generated by a separate timer unit (not shown) and are provided to both systems 100, 200, for example, via at least one of the above-mentioned interfaces or a separate wired or wireless data connection.

The method according to the invention advantageously allows a considerable saving of transmission bandwidth in the area of the data connection 10 (FIG. 1) and of computation time in the computer system 200. At the same time, it is advantageously ensured that, if needed, image data with maximum possible quality, namely the primary (stored) image data BD1, BD1′, can be supplied to the computer system 200.

In FIG. 3, in the computer system 200, a so-called host application is indicated by means of the reference numeral 202, which can comprise an image analysis functionality 202a and an image processing functionality 202b.

The image analysis functionality 202a is used, for example, to analyze the secondary image data BD2 received in the computer system 200, in particular with a view to areas of interest that possibly have to be analyzed further with inclusion of primary image data. Furthermore, this functionality 202a can be designed to transmit one or more of the above-mentioned control commands sb to the camera system 100b.

The image processing functionality 202b can be provided, for example, to further analyze a digital image which is requested by the computer system 200 and which characterizes a portion of the primary image data BD1 or of the stored primary image data BD1′, bar for example according to a presettable image processing task such as an object recognition, a decoding of codes contained in the image data and the like.

FIG. 4A shows a simplified flow chart of an embodiment of the method according to the invention. In an optional step 300, primary image data BD1 is generated by the image sensor 110 (FIG. 2). In the following step 310, at least a portion of the primary image data BD1 generated by the image sensor 110 is stored at least temporarily in a storage unit 130 (FIG. 2) associated with the camera system 100. Thereby, stored primary image data BD1′ is obtained.

Subsequently, in step 320, at least a portion of the primary image data BD1 generated by the image sensor 110 is subjected to a data reduction by the data reduction unit 140 (FIG. 2), whereby secondary image data BD2 (FIG. 2) is obtained. Subsequently, in step 330 (FIG. 4a), the output of at least a portion of the secondary image data BD2 via the interface unit 120 to the external unit 200 occurs.

In some embodiments it is also conceivable not to output at least temporarily secondary image data BD2 via the interface unit 120 to the external unit 200. In a preferred embodiment, this can be controlled by corresponding control commands from the external unit 200 to the camera system.

Alternatively to the procedure described above in reference to step 320, at least portions of the primary image data BD′ stored in the storage unit 130 can also be subjected to a data reduction, in order to obtain the secondary image data BD2.

In other embodiments, it is furthermore conceivable to provide several storage devices in the storage unit 130, in order to fulfill the different storage purposes, for example, a first storage device for storing the primary image data for later retrieval by the external unit 200, and a second storage device for the at least temporary storage of the primary image data BD1 before the data reduction thereof by the data reduction unit 140.

FIG. 4B shows another flow chart of an embodiment of the method according to the invention. In step 350, the camera system 100b (FIG. 3) receives at least one control command sb containing control information from an external unit 200. In step 352, the camera system 100b outputs at least a portion of the stored primary image data BD1′ (FIG. 2) to the external unit 200. Alternatively or additionally to this step 352, with the output of the stored primary image data, depending on the control information, the camera system can also control an operation of the data reduction unit 140, for example, preset the degree of data reduction and the like. This is indicated in FIG. 4B by the broken-line step 354.

FIG. 4C shows a flow chart of another embodiment of the method according to the invention. In step 350, a control command sb (FIG. 3) is again received from the external unit 200. In step 356, an operation of the data reduction unit 140 of the camera system 100b is controlled depending on the control information received in the step 350.

FIG. 4D shows another flow chart of an embodiment of the method according to the invention. In the optional step 400, the computer system 200 (FIG. 1) receives the secondary image data BD2 (FIG. 3) output by the camera system 100 via the at least one interface unit 120. In step 410, the computer system 200 analyzes the received secondary image data BD2 or at least a portion of the received secondary image data BD2. In step 420, depending on a result of the analysis from step 410, at least one control command sb containing control information is output to the camera system 100. For example, by means of such a control command, a certain quantity of stored primary image data BD1′ from the camera system 100 can be requested.

The optional step 430 represents the reception of the requested image data b2′ (FIG. 3) in the computer system 200. Thus, the received image data b2′ can be analyzed by the computer system 200.

In a particularly preferred embodiment of the method according to the invention, the data reduction unit 140 (FIG. 2) can be designed, for example, to carry out, in particular with regard to the generated primary image data BD1 and/or the stored primary image data BD1′, one or more of the following procedures.

Reducing a local resolution of the image data (in at least one dimension or preferably in two dimensions),

reducing a spectral resolution of the image data (for example, by reducing the number of color channels),

reducing an amplitude resolution of the image data (for example, by an adaptation of the quantization steps used for the digital representation of the amplitude values),

reducing an image rate,

providing the image data with an identification feature (for example, image number, time stamp).

Combinations of two or more of the above-mentioned procedures, in particular also of the procedures for data reduction, are also conceivable. In other embodiments, it is moreover conceivable that the computer system 200 parametrizes the desired type of data reduction by the data reduction unit 140, that is to say, by corresponding control commands sb or associated control information, it presets, for the camera system 100b, the manner in which or the parameters with which or the techniques by which the data reduction for presettable primary image data BD1 is to be carried out.

FIG. 5A diagrammatically shows a data flow in another embodiment of the invention. By means of an image sensor not reproduced in FIG. 5A, the camera system 100 has recorded a digital image b1 which represents a certain quantity of primary image data BD1 in the sense of the above description.

Block 144 symbolizes a data reduction as can be used, for example, by the above-described data reduction unit 140. The data reduction 144 leads to a data-reduced secondary digital image b1′ which is supplied via the data connection 10 (FIG. 1) to the computer system 200. The computer system 200 performs a first image analysis depending on the data-reduced secondary image b 1′ and recognizes an area of interest which is marked in FIG. 5A symbolically with the block arrow P2. Therefore, the computer system 200 requests in the camera system 100, via a corresponding control command, a digital image stored at least temporarily in the storage 134 of the camera system 100 and having a greater information content than the data-reduced digital image b1′, which is then transmitted to the computer system 200. In the present case, the area of interest is characterized by a bar code BC. The computer system 200 can carry out an additional analysis of the bar code BC, advantageously based on the digital image requested by means of the control command sb and contained in the primary image data or the stored primary image data. For example, an image processing can be carried out to the effect that the barcode BC contained in the requested digital image is evaluated (compare block B1).

FIG. 5B shows an arrangement 100, 200 similar to FIG. 5a, except that the highly diagrammatic images b1, b1' of FIG. 5A are replaced by actual screened black-and-white images.

FIG. 6 shows another embodiment of the camera system 100c according to the invention. The camera system 100c can have, for example, a functionality as described above in reference to the embodiments 100, 100a, 100b or a combination thereof. By means of the block 100c ′, the functionality of the camera system itself is marked here, which comprises, for example, the image sensor 110 as well as optionally additional components 120, 130, 140, 141, 150. In contrast to the above-described embodiment, the camera system 100c comprises an embedded central processing unit 200′ (English: embedded CPU), that is to say a central processing unit integrated in the camera system 100c, for example, it can also be arranged in a common housing (not shown) of the camera system 100c. Between the embedded central processing unit 200′ and the function block 100c′, a data connection 10′ is provided. The embedded central processing unit 200′ can have, for example, a functionality similar to the above-described component 200 (FIG. 1). The data connection 10′ can have, for example, a functionality similar to the above-described data connection 10 (FIG. 1).

The present invention advantageously enables a reduction of the required transmission bandwidth between the camera system 100 (FIG. 1) and the computer system 200. Furthermore, the computer system 200 needs to apply less processing power in order to receive and process or preprocess secondary image data BD2 originally transmitted according to standard procedure according to an embodiment.

In a particularly preferable variant, advantageously relatively small thumbnails (which thus have, for example, a comparatively low local resolution or generally a lower data quantity than the primary image data) can be transmitted as secondary image data BD2 to the computer system 200, and software present in the computer system 200, for example, an image processing system or an image analysis system, optionally determines areas of interest of the thumbnails and, if needed, requests the areas of interest in the form of at least temporarily buffered primary image data from the camera system.

In another advantageous embodiment, thumbnails which have no content of interest can be completely ignored. In other words, these thumbnails can be rejected by the computer system 200, and, in particular, no primary image data corresponding to these thumbnails to be rejected needs to be requested in the camera system by the computer system.

Subsequently, the image data of interest, which, for example, also represents only sections of image data stored with high resolution in the camera system, can advantageously be transmitted to the computer system and supplied there to an analysis.

In particular, for the transmission of the secondary image data to the computer system, the principle according to the invention enables relatively high image repetition rates. Advantageously, for the implementation of the data interfaces 120, 122, standardized data interfaces can also be used, which should make possible a largely lower maximum data rate than would be necessary for direct transmission of the primary image data BD1.

Particularly advantageously, in preferred embodiments, the computer system 200 can determine which portions of the image data should be transmitted in a comparatively greater or maximum possible quality from the camera system 100 to the computer system 200.

In other advantageous embodiments, the computer system 200 can be programmed by application developers with, for example, algorithms for image processing that are known per se. In particular, for the implementation of an image processing in the computer system 200, no specialized knowledge is required concerning an internal design of the camera system 100, 100a, 100b or the components thereof.

Also advantageously, the use of the principle according to the invention allows short development times for image processing systems and a high flexibility.

In some embodiments, for the data interface ten, for example, a GB (Gigabit) Ethernet interface can be used, which provides a potential transmission rate of approximately 125 MB (megabytes) per second. Alternatively or additionally, one or more of the following data interface types can also be used: 10 GB Ethernet, USB3, CameraLink HS, CoaxPress.

What is claimed is:

1. A camera system with an image sensor for generating primary image data and at least one interface unit for the data exchange with an external unit, wherein the camera system is designed to store at least a portion of the primary image data generated by the image sensor at least temporarily in a storage unit associated with the camera system, in order to obtain stored primary image data, to subject at least one of a portion of the primary image data generated by the image sensor and of the stored primary image data to a data reduction by means of a data reduction unit, in order to obtain secondary image data, and to output at least a portion of the secondary image data via the at least one interface unit to the external unit.

2. The camera system according to claim 1, wherein the camera system is designed to receive at least one control command containing control information from an external unit, wherein, in particular, the camera system is designed to influence an operation of the camera system depending on the control information.

3. The camera system according to claim 2, wherein the camera system is designed:
to output, depending on the control information, at least a portion of the stored primary image data to the external unit, and/or
to control, depending on the control information, an operation of the data reduction unit.

4. The camera system according to claim 1, wherein the data reduction unit is designed to carry out with regard to at least one of the generated primary image data and the stored primary image data, at least one of the following procedures:
reducing a spatial resolution of the image data,
reducing a spectral resolution of the image data,
reducing an amplitude resolution of the image data,
reducing an image rate, and
providing the image data with an identification feature.

5. The camera system according to claim 1, wherein the control unit comprises at least one circular buffer.

6. An image processing system comprising:
at least one camera system comprising an image sensor for generating primary image data and at least one interface unit for the data exchange with an external unit, wherein the camera system is designed to store at least a portion of the primary image data generated by the image sensor at least temporarily in a storage unit associated with the camera system, in order to obtain stored primary image data, to subject at least a portion of the primary image data generated by the image sensor and/or of the stored primary image data to a data reduction by means of a data reduction unit, in order to obtain secondary image data, and in order to output at least a portion of the secondary image data via the at least one interface unit to the external unit;
at least one computer system, wherein the computer system is designed to receive the secondary image data output by the camera system via the at least one interface unit, to analyze at least a portion of the received secondary image data, and to output, depending on a result of the analysis, at least one control command containing control information to the camera system.

7. The image processing system according to claim 6, wherein the computer system is designed to cause, by means of the control command the camera system to output at least a portion of the stored primary image data as requested image data to the computer system, and to receive the requested image data from the camera system, wherein, in particular, the computer system analyzes the received requested image data.

8. A method for operating a camera system with an image sensor for generating primary image data and with an interface unit for the data exchange with an external unit, wherein the method comprises the following steps: at least temporary storing of at least a portion of the primary image data generated by the image sensor in a storage unit associated with the camera system, whereby stored primary image data is obtained, subjecting at least a portion of the primary image data generated by the image sensor and/or of the stored primary image data to a data reduction, whereby secondary image data is obtained, outputting at least a portion of the secondary image data via an interface unit to an external unit.

9. The method according to claim 8, wherein the camera system receives at least one control command containing control information from an external unit, wherein the camera system performs at least one of the following:
depending on the control information, outputs at least a portion of the stored primary image data to the external unit, and,
depending on the control information, controls an operation of the data reduction unit.

10. A method for operating an image processing system with at least one camera system comprising an image sensor for generating primary image data and at least one interface unit for the data exchange with an external unit, wherein the camera system is designed to store at least a portion of the primary image data generated by the image sensor at least temporarily in a storage unit associated with the camera system, in order to obtain stored primary image data, to subject at least a portion of the primary image data generated by the image sensor and/or of the stored primary image data to a data reduction by means of a data reduction unit, in order to obtain secondary image data, and in order to output at least a portion of the secondary image data via the at least one interface unit to the external unit, and with at least one computer system, comprising the steps of receiving in the computer system the secondary image data output by the camera system via the at least one interface unit, analyzing at least a portion of the received secondary image data, and outputting, depending on a result of the analysis, at least one control command containing control information to the camera system.

11. The method according to claim 10, wherein the computer system, by means of the control command, causes the camera system to output at least a portion of the stored primary image data as requested image data to the computer system and receives the requested image data from the camera system, wherein, in particular, the computer system analyzes the received requested image data.
